(19) United States
(12) Patent Application Publication
(10) Pub. No.: US 2025/0367938 A1
(43) Pub. Date: Dec. 4, 2025

(54) Liquid Ejection Device

(71) Applicant: SEIKO EPSON CORPORATION, Tokyo (JP)

(72) Inventor: Chikara KOJIMA, Matsumoto (JP)

(21) Appl. No.: 19/225,266

(22) Filed: Jun. 2, 2025

(30) Foreign Application Priority Data
Jun. 3, 2024 (JP) 2024-089877

(51) Int. Cl. B41J 2/175; B41J 2/18

(52) U.S. Cl. CPC B41J 2/17566; B41J 2/17596; B41J 2/18

(57) ABSTRACT

A liquid ejection device including an ejection head that ejects a liquid, a liquid supply flow path that supplies the liquid to the ejection head, an ultrasonic generator provided with an ultrasonic element that transmits ultrasonic waves in a first direction that intersects with a flow direction of the liquid in the liquid supply flow path, and a branch flow path that branches in a second direction that intersects the flow direction and the first direction from a position of the liquid supply flow path where the ultrasonic waves are transmitted, wherein the ultrasonic generator that generates a gradient of acoustic radiation force in which the acoustic radiation force increases from the liquid supply flow path toward the branch flow path.

The present application is based on, and claims priority from JP Application Serial Number 2024-089877, filed Jun. 3, 2024, the disclosure of which is hereby incorporated by reference herein in its entirety.

### BACKGROUND

### 1. Technical Field

The present disclosure relates to a liquid ejection device.

### 2. Related Art

In the related art, in a liquid ejection device for ejecting a liquid, a mesh type filter is disposed in a liquid supply passage in order to remove foreign matter contained in the liquid to be ejected (for example, see JP-A-2005-169200).

However, in a configuration in which a mesh-type filter is provided in the supply path of the liquid ejection device, if the filter becomes clogged, it becomes difficult for the liquid to flow. For this reason, it is necessary to replace the filter, and there is a problem that it takes time and effort to replace the filter and the cost related to the filter.

### SUMMARY

A liquid ejection device according to the first aspect of the present disclosure including an ejection head that ejects a liquid, a liquid supply flow path that supplies the liquid to the ejection head, an ultrasonic generator provided with an ultrasonic element that transmits ultrasonic waves in a first direction that intersects with a flow direction of the liquid in the liquid supply flow path; and a branch flow path that branches in a second direction that intersects the flow direction and the first direction from a position of the liquid supply flow path where the ultrasonic waves are transmitted, wherein the ultrasonic generator that generates a gradient of acoustic radiation force in which the acoustic radiation force increases from the liquid supply flow path toward the branch flow path.

### BRIEF DESCRIPTION OF THE DRAWINGS

FIG. 1 is a schematic view showing an example of a liquid ejection device according to an embodiment of the present disclosure.

FIG. 2 is a view showing a schematic configuration of the ejection head of the present embodiment.

FIG. 3 is a cross-sectional view showing a schematic configuration of a foreign matter removal mechanism provided in a liquid supply flow path.

FIG. 4 is a cross-sectional view showing a schematic configuration of the foreign matter removal mechanism when the foreign matter removal mechanism is cut along line A-A of FIG. 3.

FIG. 5 is a cross-sectional view showing a schematic configuration of the foreign matter removal mechanism when the foreign matter removal mechanism is cut along line B-B in FIG. 3.

FIG. 6 is a schematic plan view showing an example of an ultrasonic element of the present embodiment.

FIG. 7 is a cross-sectional view of the ultrasonic element cut along line C-C of FIG. 6.

FIG. 8 is a diagram showing a relationship between an acoustic radiation field and a voltage value of a driving voltage applied to an ultrasonic element.

FIG. 9 is a diagram showing an example of a drag field and an acoustic radiation field in the ultrasonic region of the liquid supply flow path in the present embodiment.

### DESCRIPTION OF EMBODIMENTS

Hereinafter, a liquid ejection device according to an embodiment of the present disclosure will be described.

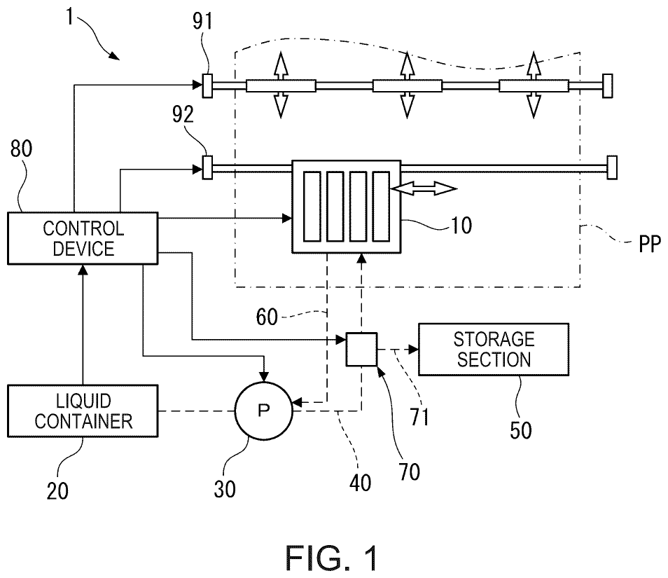

FIG. 1 is a schematic view showing an example of the liquid ejection device 1 of the present embodiment.

The liquid ejection device 1 is a device that ejects the liquid to an object, and in the present embodiment, as an example thereof, an ink jet printer will be described that ejects ink as the liquid to a medium PP such as printing paper.

As shown in FIG. 1, the liquid ejection device 1 includes an ejection head 10, a liquid container 20, a pump 30, a liquid supply flow path 40, a storage section 50, a circulation flow path 60, a foreign matter removal mechanism 70, and a control device 80. The control device 80 is, for example, a computer including a processor such as a central processing unit (CPU) and a memory circuit such as a semiconductor memory. The control device 80 controls the operation of each unit of the liquid ejection device 1 by the processor executing a program stored in advance in the memory circuit.

The liquid is stored in the liquid container 20. The liquid is, for example, an ink in which a pigment is dispersed in a solvent. The liquid is not limited to ink containing a pigment, and may be ink containing a dye or ink containing both a pigment and a dye. The liquid container 20 is, for example, a cartridge that can be attached to and detached from the liquid ejection device 1, a bag-shaped ink pack made of a flexible film, an ink tank that can be refilled with ink, or the like. The liquid container 20 stores a plurality of types of inks with different colors.

The pump 30 supplies the liquid stored in the liquid container 20 to the ejection head 10. In the present embodiment, the pump 30 can select any one of a plurality of types of liquids stored in the liquid container 20 and supply the selected liquid to one ejection head 10 under the control of the control device 80. That is, each of the plurality of types of liquids can be individually supplied to the ejection head 10 of the present embodiment by the control device 80 switching the type of liquid. The pump 30 recovers the liquid stored in the ejection head 10 through the circulation flow path 60 and returns the recovered liquid to the ejection head 10 through the liquid supply flow path 40.

The liquid supply flow path 40 is a flow path for connecting the pump 30 and the ejection head 10. In the present disclosure, the foreign matter removal mechanism 70 that removes the foreign matter contained in the liquid is provided between the pump 30 and the ejection head 10 in the liquid supply flow path 40. The foreign matter is made to flow to the storage section 50 by the foreign matter removal mechanism 70. The flow of the liquid flowing through the liquid supply flow path 40 is assumed to be laminar flow. In particular, when the liquid ejection device 1 is an inkjet printer, the flow velocity of the liquid (ink) supplied from the liquid container 20 is sufficiently small, and the liquid flows in a laminar flow. Details of the liquid supply flow path 40 and the foreign matter removal mechanism 70 will be described later.

The storage section 50 stores foreign matter separated from the liquid supply flow path 40 by the foreign matter removal mechanism 70. The storage section 50 may be provided so as to be detachably connected to the branch flow path 71 of the foreign matter removal mechanism 70.

As described above, the circulation flow path 60 is a flow path for returning the liquid in the ejection head 10 to the liquid supply flow path 40.

The liquid ejection device 1 of the present disclosure further includes a movement mechanism 91 and a transport mechanism 92. The movement mechanism 91 transports the medium PP in a predetermined direction under the control of the control device 80. The transport mechanism 92 reciprocates the ejection head 10 along a direction crossing the moving direction of the medium PP under the control of the control device 80. The configuration of the movement mechanism 91 and the transport mechanism 92 is not particularly limited. For example, the movement mechanism 91 may have a configuration in which the medium PP is nipped by a plurality of rollers and moved by the rotation of the rollers, and the medium PP may be sent out in a predetermined direction by another actuator. As the transport mechanism 92, for example, the ejection head 10 may be moved by driving an endless belt on which the ejection head 10 is held, or an ejection head 10 that is held so as to be movable forward and backward by a support bar may be moved forward and backward by rotation of a screw. The transport direction of the medium PP and the movement direction of the ejection head 10 are not limited to being orthogonal, and may intersect at a predetermined angle. In the embodiment, a configuration in which the ejection head 10 is relatively moved with respect to the medium PP may be adopted, and a configuration in which any one of the medium PP and the ejection head 10 is moved over a two-dimensional plane may be adopted. The liquid container 20 and the pump 30, together with the ejection head 10, may be housed in a storage case (not shown) and moved together with the ejection head.

The ejection head 10 ejects the liquid from part or all of a plurality of nozzles provided in the ejection head 10 under the control of the control device 80. In the present disclosure, the ejection direction of the liquid is a direction toward the medium PP. The ejection head 10 ejects the liquid from the nozzles while interlocking the transport of the medium PP by the movement mechanism 91 and the reciprocating movement of the ejection head 10 by the transport mechanism 92, and deposits the liquid on the surface of the medium PP. As a result, a desired image is formed on the surface of the medium PP.

### Detailed Configuration of Ejection Head 10

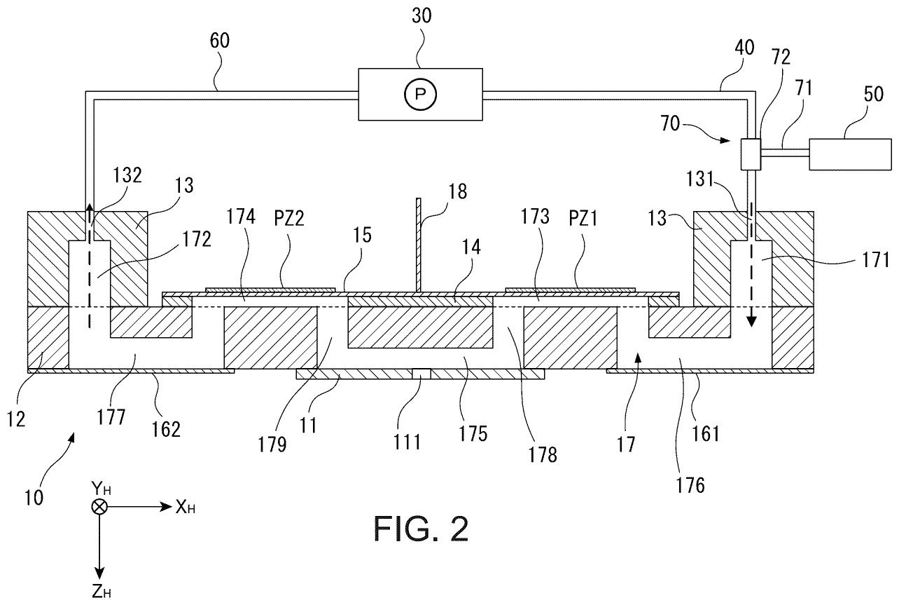

FIG. 2 is a view showing a schematic configuration of the ejection head 10. The direction of the dashed lines in FIG. 2 indicate the direction in which the liquid flows. The ejection head 10 includes a nozzle substrate 11, a communicating plate 12, a common liquid chamber forming substrate 13, a pressure chamber substrate 14, a pressure application plate 15, sealing sheets 161 and 162, and a wiring substrate 18.

Here, in the ejection head 10, the direction of liquid ejection is defined as the Z_{H} direction, the direction orthogonal to the Z_{H} direction is defined as the X_{H} direction, and the direction orthogonal to both the X_{H} direction and the Z_{H} direction is defined as the Y_{H} direction.

The nozzle substrate 11 is a plate-like member disposed to be substantially parallel to the X_{H}Y_{H} plane when the medium PP is being transported to the printing position. A nozzle 111 functioning as a liquid ejection port is formed on the nozzle substrate 11. The nozzle 111 is a through hole provided in the nozzle substrate 11. The nozzle 111 may be formed in an inner circumferential cylindrical shape parallel to the liquid ejection direction, or it may be formed so that the opening diameter narrows along the liquid ejection direction.

The communicating plate 12 is provided on the surface of the nozzle substrate 11 on the −Z_{H} side. The communicating plate 12 is a plate-like member disposed so as to be substantially parallel to the X_{H}Y_{H} plane. The communicating plate 12 is provided with a plurality of through holes and forms a part of the head internal flow path 17 (to be described later). The communicating plate 12 is manufactured, for example, by processing a Si single crystal substrate using semiconductor manufacturing techniques.

The common liquid chamber forming substrate 13 is provided on the surface of the communicating plate 12 on the −Z_{H} side. The first common liquid chamber 171 and the second common liquid chamber 172 are formed in a region surrounded by the common liquid chamber forming substrate 13 and the communicating plate 12. The first through hole 131 penetrating through the common liquid chamber forming substrate 13 is formed on the −Z_{H} side of the first common liquid chamber 171. The first common liquid chamber 171 is connected to the liquid supply flow path 40 via the first through hole 131. A second through hole 132 is formed on the −Z_{H} side of the second common liquid chamber 172. The second common liquid chamber 172 is connected to the circulation flow path 60 via the second through hole 132. The common liquid chamber forming substrate 13 is formed, for example, by injection molding of a resin material.

The pressure chamber substrate 14 is a plate-shaped member provided on the surface of the communicating plate 12 on the −Z_{H} side. The pressure chamber substrate 14 is disposed so as to be substantially parallel to the X_{H}Y_{H} plane. The pressure chamber substrate 14 is manufactured, for example, by processing an Si single crystal substrate using semiconductor manufacturing techniques.

The pressure application plate 15 is a plate-shaped member provided on the surface of the pressure chamber substrate 14 on the −Z_{H} side. The pressure application plate 15 is also an elastically vibratable member. The pressure chambers 173 and 174 are formed by the communicating plate 12, the pressure chamber substrate 14, and the pressure application plate 15. The pressure chambers 173 and 174 are spaces extending in the X_{H}-axis direction. The pressure application plate 15 is disposed so as to be substantially parallel to the X_{H}Y_{H} plane. The head side piezoelectric elements PZ1 and PZ2 corresponding to the pressure chambers 173 and 174, respectively, are provided on the surface of the pressure application plate 15 on the −Z_{H} side. The head side piezoelectric element PZ1 and PZ2 are energy conversion elements that convert electric energy transmitted from the control device 80 into kinetic energy. The pressure application plate 15 is bent by the displacement of the head side piezoelectric elements PZ1 and PZ2, thereby applying pressure to the liquid in the pressure chambers 173 and 174. With this pressure, the liquid is ejected from nozzle 111.

The sealing sheets 161 and 162 are provided on the surface of the communicating plate 12 on the +Z_{H} side. An elastic material, for example, is used for the sealing sheets 161 and 162. The sealing sheets 161 and 162 absorb the pressure fluctuation of the liquid in the head internal flow path 17 (to be described later).

The wiring substrate 18 is mounted on the −Z_{H} side of the pressure application plate 15. The wiring substrate 18 is a component for electrically connecting the control device 80 and the ejection head 10. As the wiring substrate 18, for example, a flexible wiring substrate such as a flexible printed circuit board (flexible printed circuits, FPC) is used. The wiring substrate 18 supplies a drive signal to the head side piezoelectric elements PZ1 and PZ2 based on a control signal of the control device 80.

In the ejection head 10, a head internal flow path 17 is formed by the communicating plate 12, the pressure chamber substrate 14, the pressure application plate 15, the common liquid chamber forming substrate 13, and the sealing sheets 161 and 162.

The head internal flow path 17 is a flow path in the ejection head 10 up to where the liquid supplied from the liquid supply flow path 40 is discharged to the circulation flow path 60. One end of the head internal flow path 17 is connected to the liquid supply flow path 40, and the other end thereof is connected to the circulation flow path 60. Specifically, the head internal flow path 17 includes a first common liquid chamber 171, a second common liquid chamber 172, pressure chambers 173 and 174, a nozzle flow path 175, a first connecting flow path 176, a second connecting flow path 177, a third connecting flow path 178, and a fourth connecting flow path 179. The first connecting flow path 176 is a flow path connecting the first common liquid chamber 171 and the pressure chamber 173. The second connecting flow path 177 connects the pressure chamber 174 and the second common liquid chamber 172. The third connecting flow path 178 connects the pressure chamber 173 and the nozzle flow path 175. The fourth connecting flow path 179 connects the nozzle flow path 175 and the pressure chamber 174. The nozzle flow path 175 is a flow path extending in the X_{H}-axis direction and is connected to the nozzle 111 in the vicinity of the center in the X_{H}-axis direction.

In the present disclosure, the liquid supplied from the liquid container 20 by the pump 30 is supplied to the first common liquid chamber 171 via the liquid supply flow path 40. A part of the liquid flowing into the first common liquid chamber 171 flows into the pressure chamber 173 via the first connecting flow path 176. A part of the liquid that flows into the pressure chamber 173 flows into pressure chamber 174 via the third connecting flow path 178, the nozzle flow path 175, and the fourth connecting flow path 179 in this order. A part of the liquid that flows into the pressure chamber 174 is discharged to the circulation flow path 60 after passing through the second connecting flow path 177 and the second common liquid chamber 172 in this order. The discharged liquid is supplied again to the first common liquid chamber 171 via the liquid supply flow path 40 by the pump 30. In this way, the liquid circulates through the liquid supply flow path 40, the ejection head 10, and the circulation flow path 60 in this order.

### Detailed Configuration of Foreign Matter Removal Mechanism 70 Provided in Liquid Supply Flow Path 40

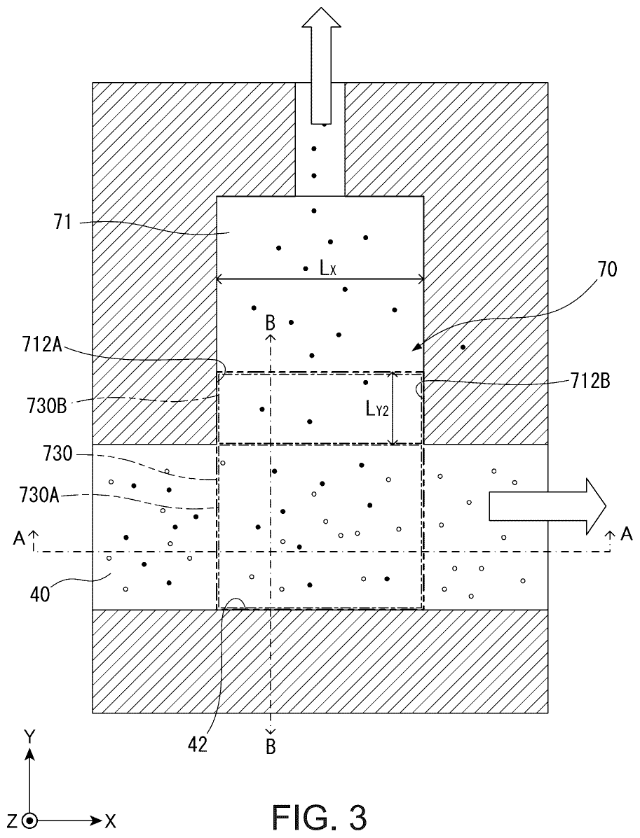

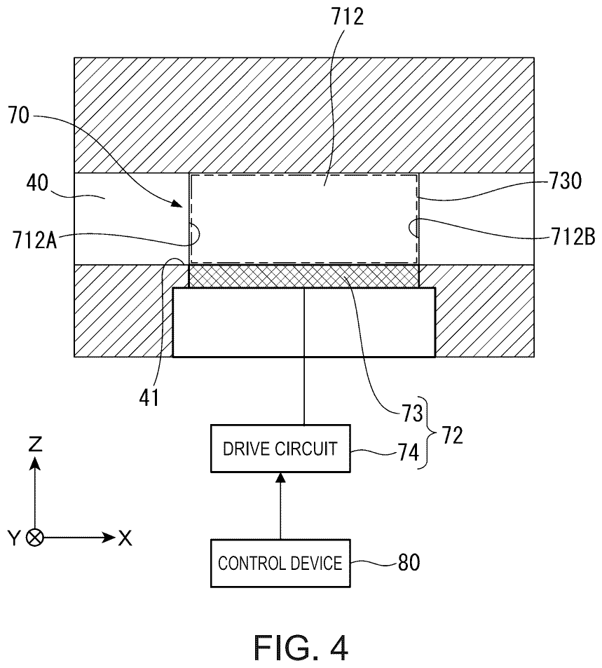

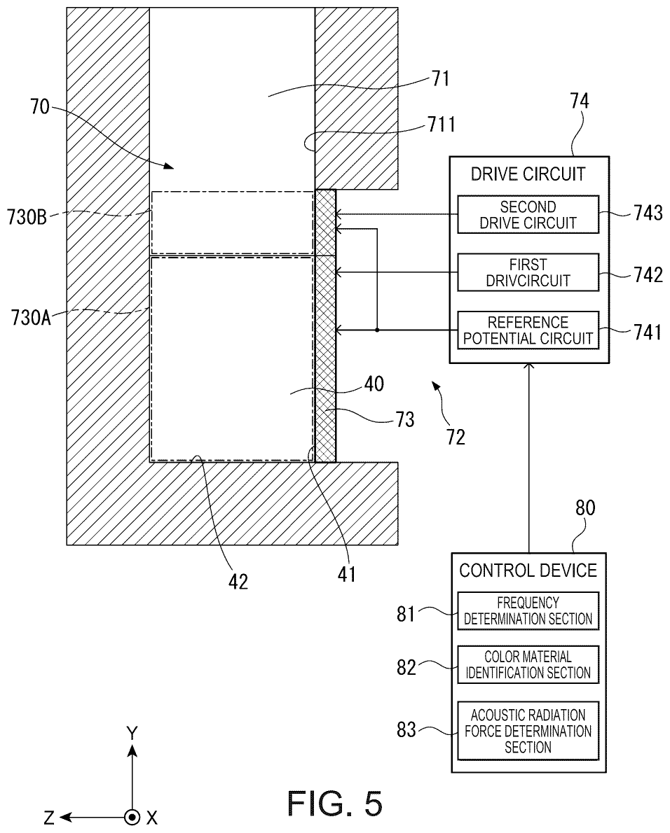

FIG. 3 is a cross-sectional view showing a schematic configuration of the foreign matter removal mechanism 70 provided in the liquid supply flow path 40. In FIG. 3, the flow direction of the liquid flowing through the liquid supply flow path 40 is set as the X direction (flow direction of the present disclosure), a direction orthogonal to the X direction is set as the Z direction (first direction of the present disclosure), and a direction orthogonal to both the X direction and the Z direction is set as the Y direction (second direction of the present disclosure). FIG. 4 is a cross-sectional view showing a schematic configuration of the foreign matter removal mechanism 70 when the foreign matter removal mechanism 70 is cut along line A-A of FIG. 3. FIG. 5 is a cross-sectional view showing a schematic configuration of the foreign matter removal mechanism 70 when the foreign matter removal mechanism 70 is cut toward the front side of the paper on line B-B of FIG. 3. In FIG. 3, black dots indicate foreign matter or bubbles in the liquid, and white circles indicate coloring materials.

As shown in FIG. 3 and FIG. 5, the foreign matter removal mechanism 70 is provided with a branch flow path 71 that branches in the Y direction from the liquid supply flow path 40, which causes liquid to flow in the X direction. The branch flow path 71 is connected to the storage section 50, and foreign matter in the liquid are stored in the storage section 50 through the branch flow path 71. Although the present embodiment shows an example in which the branch flow path 71 and the storage section 50 have different configurations, a part of the branch flow path 71 may be configured to serve as the storage section 50.

The foreign matter removal mechanism 70 includes an ultrasonic generator 72 which transmits ultrasonic waves from the liquid supply flow path 40 to a part of the branch flow path 71 at a connection portion between the liquid supply flow path 40 and the branch flow path 71. The ultrasonic generator 72 includes an ultrasonic element 73 that transmits ultrasonic waves to the liquid flowing through the liquid supply flow path 40 and the branch flow path 71, and a drive circuit 74 (see FIGS. 4 and 5) that outputs a driving voltage to transmit ultrasonic waves to the ultrasonic element 73.

As shown in FIGS. 4 and 5, the ultrasonic element 73 is provided from the −Z side of the wall surface 41 of the liquid supply flow path 40 to the −Z side of the wall surface 711 of the branch flow path 71. More specifically, the ultrasonic element 73 is provided at least in a range from the −Y side end portion (a corner portion with surface 42 on the −Y side: refer to FIGS. 3 and 5) on the wall surface 41 on the −Z side of the liquid supply flow path 40 to a predetermined length L_{Y2} from a connection position between the liquid supply flow path 40 and the branch flow path 71. The ultrasonic element 73 is provided in the range of width L_{X} in the X direction, at least covering between the −Z side wall surface 711 of the branch flow path 71, the −X side wall surface 712A of the branch flow path 71 (see FIG. 3), and the +X side wall surface 712B (see FIG. 3). As shown in FIG. 3, when viewed from the Z direction, a region of the liquid supply flow path 40 and the branch flow path 71 that overlaps the ultrasonic element 73 is the ultrasonic region 730 where the ultrasonic waves transmitted from the ultrasonic element 73 propagate. Within the ultrasonic region 730, the part that overlaps with the liquid supply flow path 40 is referred to as the first region 730A, and the part that overlaps with the branch flow path 71 is referred to as the second region 730B.

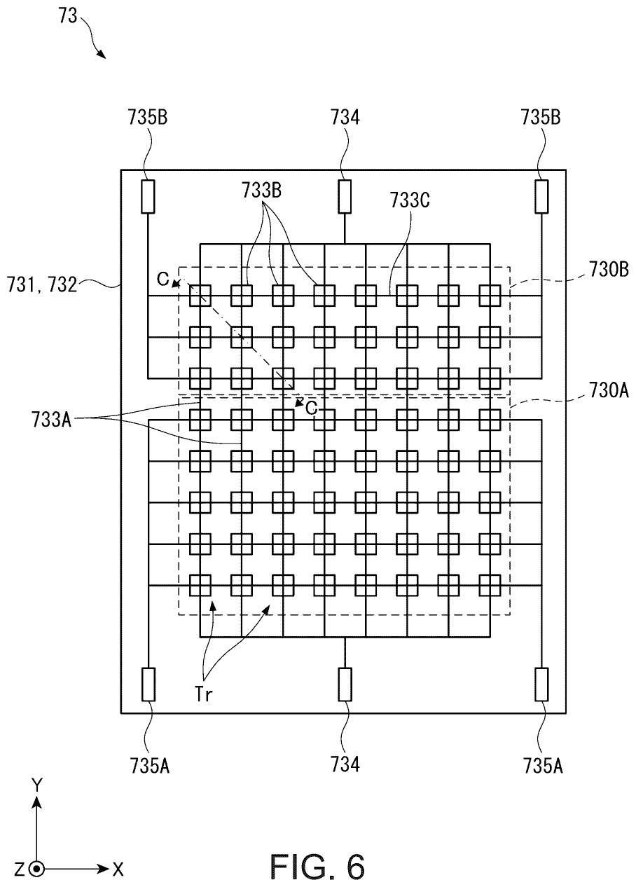

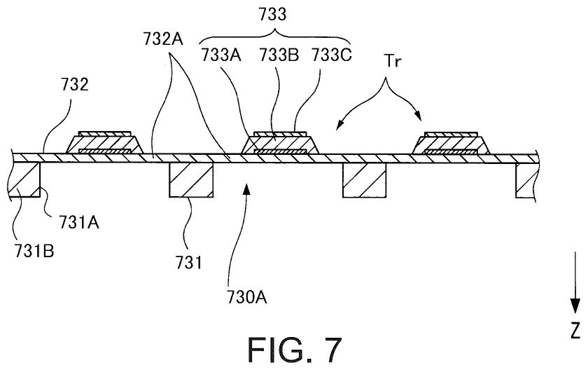

FIG. 6 is a schematic plan view showing an example of the ultrasonic element 73 of the present embodiment, and FIG. 7 is a cross-sectional view of the ultrasonic element 73 cut along line C-C of FIG. 6.

As shown in FIG. 6, a plurality of ultrasonic transducers Tr are disposed in a two-dimensional array in the ultrasonic element 73 along the X and Y directions.

In FIG. 6, the number of disposed ultrasonic transducers Tr is reduced for convenience of description, but actually more ultrasonic transducer Tr may be disposed.

As shown in FIG. 7, the ultrasonic element 73 includes an element substrate 731, a diaphragm 732 provided on the element substrate 731, and a piezoelectric element 733 provided on the diaphragm 732.

The element substrate 731 is composed of a semiconductor substrate such as Si. The element substrate 731 is provided with substrate openings 731A corresponding to the respective ultrasonic transducers Tr. In this embodiment, each substrate opening 731A is a through hole penetrating the element substrate 731 in the substrate thickness direction (Z direction), and the diaphragm 732 is provided on the −Z side of the through holes.

The diaphragm 732 is made of, for example, a laminated body of SiO₂ and ZrO₂, and is provided so as to cover the entire −Z side of the element substrate 731. That is, the diaphragm 732 is supported by partition wall 731B that constitutes the substrate opening 731A and closes the −Z side of the substrate opening 731A. The thickness dimension of the diaphragm 732 is significantly smaller than that of the element substrate 731.

The piezoelectric elements 733 are provided at the diaphragm 732 that closes the respective substrate opening 731A. The piezoelectric element 733 is formed of, for example, a stacked body in which the lower electrode 733A, the piezoelectric film 733B, and the upper electrode 733C are stacked from the diaphragm 732 toward the −Z side.

Here, the portion of the diaphragm 732 that closes the substrate opening 731A configures a vibrator 732A, and one ultrasonic transducer Tr is configured by the vibrator 732A and the piezoelectric element 733.

The +Z side surface of the vibrator 732A is a liquid contact surface that comes into contact with the liquid of the liquid supply flow path 40 or the branch flow path 71.

In such an ultrasonic transducer Tr, when a rectangular wave voltage (drive signal) of a predetermined frequency is applied between the lower electrode 733A and the upper electrode 733C, the piezoelectric film 733B bends, and the vibrating section 732A vibrates in the Z direction, which is the normal direction of the liquid contact surface, thereby transmitting ultrasonic waves to the +Z side.

In the present embodiment, for example, the lower electrodes 733A of the ultrasonic transducers Tr arranged in the Y direction are connected to each other. As shown in FIG. 6, the lower electrodes 733A are connected to the common terminal 734. The common terminal 734 is electrically connected to the drive circuit 74, for example, via a flexible printed circuit board, and applies a reference potential to each of the lower electrodes 733A.

The upper electrodes 733C of the ultrasonic transducers Tr arranged in the X direction are connected to each other. Here, a region in which the ultrasonic transducers Tr facing the first region 730A are disposed is referred to as the first element region Ar1, and a region in which the ultrasonic transducers Tr facing the second region 730B are disposed is referred to as the second element region Ar2. The upper electrode 733C of each ultrasonic transducer Tr disposed in the first element region Ar1 is connected to the first drive terminals 735A, and this first drive terminals 735A are electrically connected to the drive circuit 74, for example, via a flexible printed circuit board or the like. The upper electrodes 733C of the respective ultrasonic transducers Tr disposed to face the position (second region 730B) facing the branch flow path 71 are connected to the second drive terminals 735B, and the second drive terminals 735B are electrically connected to the drive circuit 74, for example, via a flexible printed circuit board or the like.

The drive circuit 74 functions as a radiation force adjustor of the present disclosure and, as shown in FIG. 5, includes a reference potential circuit 741, a first drive circuit 742, and a second drive circuit 743. The reference potential circuit 741 applies a reference potential to the lower electrode 733A of each ultrasonic transducer Tr via the common terminal 734.

The first drive circuit 742 applies, via the first drive terminal 735A, a first drive voltage to the upper electrode 733C of the ultrasonic transducer Tr opposed to the first region 730A. The second drive circuit 743 applies, via the second drive terminal 735B, a second drive voltage to the upper electrode 733C of the ultrasonic transducer Tr opposed to the second region 730B.

Under the control of the control device 80, the drive circuit 74 controls the drive frequencies of the first drive voltage and the second drive voltage output from the first drive circuit 742 and the second drive circuit 743. As a result, a standing wave is generated in the first region 730A and the second region 730B.

Under the control of control device 80, the drive circuit 74 controls the voltage values of the first drive voltage and the second drive voltage output from first drive circuit 742 and second drive circuit 743. As a result, the acoustic radiation force produced by the standing wave formed in the first region 730A is made different from the acoustic radiation force produced by the standing wave formed in the second region 730B. Specifically, the voltage values of the first driving voltage and the second driving voltage output from the first drive circuit 742 and the second drive circuit 743 are controlled so that the acoustic radiation force of the second region 730B is larger than that of the first region 730A.

### Functional Configuration of Control Device 80

As described above, the control device 80 is configured to include a processor and a memory circuit, and by the processor executing a program stored in the memory circuit, as shown in FIG. 5 it functions as a frequency determination section 81, a coloring material identification section 82, an acoustic radiation force determination section 83, and the like. Note that the control device 80 performs drive control (liquid ejection control) of the head side piezoelectric elements PZ1 and PZ2 of the ejection head 10, drive control of the movement mechanism 91 and the transport mechanism 92, and drive control of the pump 30, but description of these controls is omitted in the present embodiment.

The frequency determination section 81 determines the frequency for forming the standing wave in the ultrasonic region 730. The frequency determination section 81 sweeps the frequencies of the ultrasonic waves output from the ultrasonic transducer Tr in the first element region Ar1 opposed to the first region 730A, and measures the impedance between the common terminal 834 and the first drive terminal 835A (the impedance related to the first element region Ar1). Then, the frequency at which the impedance takes a maximum value is identified as the frequency forming the standing wave. The same applies to the frequencies of the ultrasonic waves output from the ultrasonic transducer Tr in the second element region Ar2 opposed to the second region 730B.

As the frequency that forms the standing wave, in a case where the flow path width in the Z direction of the liquid supply flow path 40 and the branch flow path 71 is constant, a fixed frequency corresponding to the flow path widths may be used.

The coloring material identification section 82 identifies fine particles (coloring material in the present embodiment) that are not to be captured in the liquid.

In the present embodiment, in the foreign matter removal mechanism 70, the fine particles are moved from the liquid supply flow path 40 to the branch flow path 71 using the gradient of the acoustic radiation force of the ultrasonic wave. By increasing the driving voltage applied to the ultrasonic element 73, it is possible to output ultrasonic waves having a large acoustic radiation force, but if the acoustic radiation force is too large, the foreign matter removal mechanism 70 may remove the coloring material to be output from the nozzle 111 together with the liquid.

In the present embodiment, the coloring material identification section 82 identifies the fine particles to be captured and the fine particles not to be captured. Specifically, the coloring material information of the liquid contained in the liquid container 20 set in the liquid ejection device 1 is identified. The coloring material identification section 82 may identify the coloring material information based on the data input by the user.

Alternatively, the liquid container 20 may include a data chip on which the coloring material information is written, and when the liquid container 20 is installed in the liquid ejection device 1, the coloring material information may be obtained by reading the information on the data chip. The data chip may be, for example, a magnetic e device, a semiconductor memory, or code data such as a QR code (registered trademark).

The acoustic radiation force determination section 83 determines a driving voltage value of the ultrasonic waves output from the ultrasonic element 73 based on the coloring material information, and outputs a control signal to the drive circuit 74. At this time, the voltage value is set so that the voltage value of the first driving voltage output from the first drive circuit 742 becomes smaller than the voltage value of the second driving voltage output from the second drive circuit 743 and, in the first region 730A, the coloring material is not captured, but other fine particles (foreign matter, air bubbles) with a diameter equal to or larger than the fine particle diameter of the coloring material are captured and moved. The voltage value of the first driving voltage corresponding to the coloring material information may be previously stored in the memory circuit.

### Principle of Removing Fine Particles

Next, the principle of the removal of the fine particles in this embodiment will be described.

In the present embodiment, the liquid flowing through the liquid supply flow path 40 is a laminar flow as described above, and in this case, a force (hereinafter, referred to as a drag force) caused by the flow of the liquid along the X direction acts on the fine particles in the liquid. The drag force acting on the fine particles becomes smaller as the flow velocity of the liquid becomes slower. The drag force acting on the fine particles becomes smaller as the size of the fine particles becomes smaller. On the other hand, when ultrasonic waves are transmitted into the liquid, the acoustic radiation force of the ultrasonic waves acts on the fine particles. The acoustic radiation force acting on the fine particles is influenced by the physical properties (especially the acoustic impedance) of the fine particles and the size of the fine particles, becoming greater as the size of the fine particles increases and as the difference in acoustic impedance between the fine particles and the liquid becomes larger.

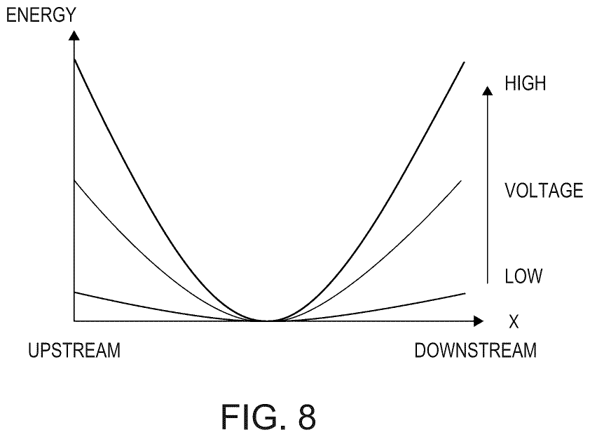

FIG. 8 is a diagram showing a relationship between acoustic radiation field and voltage value of the driving voltage applied to the ultrasonic element 73.

By increasing the voltage value of the drive voltage applied to the ultrasonic element 73, the acoustic radiation force also increases. When ultrasonic waves are transmitted from the ultrasonic generator 72 to the ultrasonic region 730, then, as shown in FIG. 8, the energy of the field (acoustic radiation field) due to the acoustic radiation force in the ultrasonic region 730 becomes a minimum value at the approximately center position of the ultrasonic region 730. In practice, the position where the minimum value is taken shifts to the downstream side (+X side) because it is affected by the field (drag field) caused by the flow of the liquid. In the present embodiment, the flow velocity of the liquid is sufficiently slow, and the position where the energy in the acoustic radiation field in the X direction is at a minimum value is within the range where the branch flow path 71 is connected, that is, within the ultrasonic region 730. In the acoustic radiation field, fine particles move from a high energy position to a low energy position. Therefore, this means that the fine particles are captured at a position where the energy in the acoustic radiation field in the X direction is at a minimum value, that is, at the central portion of the ultrasonic region 730.

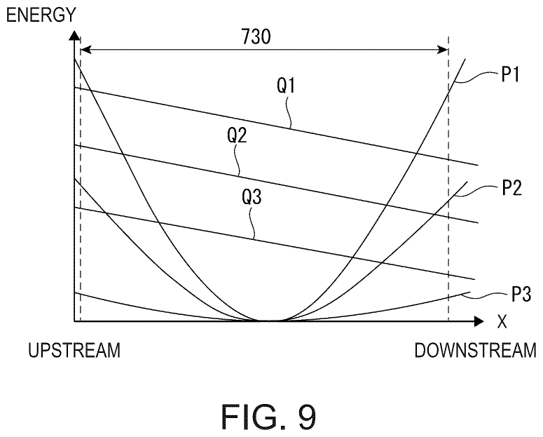

FIG. 9 is a diagram showing an example of the drag field and the acoustic radiation field in the ultrasonic region 730 of the liquid supply flow path 40. In FIG. 9, line P1 shows an acoustic radiation field for a foreign substance to be removed in the liquid, and line Q1 shows a drag field against the foreign substance. Line P2 shows the acoustic radiation field for an air bubble in a liquid, and line Q2 shows the drag field for that air bubble. Line P3 shows the acoustic radiation field for the coloring material in the liquid, and line Q3 shows the drag field for the coloring material.

In the liquid supply flow path 40, as described above, since the liquid flows in the X-direction, the fine particles in the liquid are subjected to a force due to the flow of the liquid. The energy of the drag field due to the force of the liquid flow decreases linearly along the X-direction, as shown in FIG. 9. That is, the fine particles are subjected to a constant force by the flow of the liquid, and move from the −X side which has a high energy to the +X side which has a low energy.

Now, comparing the acoustic radiation field and the drag field with respect to the coloring material in the ultrasonic region 730, the energy of the acoustic radiation field is lower than the energy of the drag field. This means that the coloring material is weekly captured by the acoustic radiation force and is caused to flow to the +X side by the flow of the liquid.

When comparing the acoustic radiation field and the drag field for the air bubble in the ultrasonic region 730, the energy of the acoustic radiation field exceeds the energy of the drag field on the +X side. In this case, this means that the air bubble is captured by the acoustic radiation force and is captured at a substantially central position (a position where the energy is minimized) of the ultrasonic region 730 against the flow of the liquid. In the present embodiment, the ultrasonic element 73 forms a standing wave in the ultrasonic region. Therefore, the air bubbles are captured at the position of the antinode of the standing wave.

When comparing the acoustic radiation field and the drag field with respect to the foreign matter in the ultrasonic region 730, the energy of the acoustic radiation field exceeds the energy of the drag field on both sides of the +X. Therefore, the foreign matter is also captured by the acoustic radiation force and is captured at a substantially central position (a position where the energy is minimized) of the ultrasonic region 730. In the present embodiment, the foreign matter is captured at the node position of the standing wave formed in the ultrasonic region 730.

Further, in the present embodiment, a difference in acoustic radiation force is provided between the first region 730A and the second region 730B of the ultrasonic region 730. That is, the acoustic radiation force in the second region 730B of the branch flow path 71 is larger than the acoustic radiation force in the first region 730A of the liquid supply flow path 40. In the second region 730B where the acoustic radiation force is large, the energy in the acoustic radiation field is smaller than that in the first region 730A where the acoustic radiation force is small. Therefore, the foreign matter and the air bubble captured by the standing wave in the first region 730A move to the second region 730B side, that is, the branch flow path 71 according to the balance of the acoustic radiation force, and are caused to flow from the branch flow path 71 to the storage section 50.

As a result, in the present embodiment, the liquid containing a large amount of foreign matter and air bubbles is removed from the liquid in the liquid supply flow path 40 and is moved to the storage section 50. The coloring material only slightly influenced by the capture by the ultrasonic wave, and is fed to the ejection head 10 on the flow of the liquid in the liquid supply flow path 40.

### Action and Effect of the Present Embodiment

The liquid ejection device 1 of this embodiment includes the ejection head 10 that ejects liquid, the liquid supply flow path 40 that supplies the liquid to the ejection head 10. the ultrasonic generator 72 provided with the ultrasonic element 73 that transmits ultrasonic waves in the Z direction, and the branch flow path 71 that branches in the Y direction from a position of the liquid supply flow path 40 where ultrasonic waves are transmitted, wherein the ultrasonic generator 72 generates the ultrasonic waves such that the acoustic radiation force increases from the liquid supply flow path 40 toward the branch flow path 71.

Therefore, foreign matter and air bubbles in the liquid flowing through the liquid supply flow path 40 can be captured by the acoustic radiation force. As the acoustic radiation force increases from the liquid supply flow path 40 toward the branch flow path 71, the foreign matter and air bubbles move from the liquid supply flow path 40 toward the branch flow path 71 in the Y direction where the energy is lower. As a result, it is possible to reduce the content of foreign matter and air bubbles from the liquid flowing through the liquid supply flow path 40, and thus to suppress clogging of the nozzle 111.

In the liquid ejection device 1 of the present embodiment, the ultrasonic generator 72 generates a standing wave in the Z direction. As a result, it is possible to cause the nodes of the standing wave to capture the foreign matter and the antinodes of the standing wave to capture the air bubbles, so that it is possible to further suppress the inflow of foreign matter and air bubbles from the liquid supply flow path 40 to the ejection head 10.

In the present embodiment, the ultrasonic generator 72 includes a drive circuit 74, and the drive circuit 74 adjusts the acoustic radiation force of the ultrasonic waves along the Y direction by controlling the ultrasonic transducers Tr in the first element region Ar1 and the ultrasonic transducers Tr in the second element region Ar2 of the ultrasonic element 73.

As a result, the foreign matter captured in the liquid supply flow path can be moved toward the branch flow path. By simply controlling the driving voltage applied to the first element region Ar1 and the driving voltage applied to the second element region Ar2, it is possible to easily form a gradient in the acoustic radiation force along the Y direction in the ultrasonic region 730.

In the present embodiment, the ultrasonic generator 72 that transmits the ultrasonic waves from the liquid supply flow path 40 to a part of the branch flow path 71.

As a result, it is possible to form the gradient of the acoustic radiation force by the ultrasonic waves from the liquid supply flow path 40 to a part of the branch flow path 71, making it easy for the foreign matter or the air bubble to move to the branch flow path 71, and it is possible to suppress the outflow of the foreign matter or the air bubble from the liquid supply flow path 40 to the ejection head 10.

In the present t embodiment, the control device 80 functions as the coloring material identification section 82 and the acoustic radiation force determination section 83, and identifies the coloring material information of the liquid by the coloring material identification section 82, and the acoustic radiation force determination section 83 determines the driving voltage value of the ultrasonic waves that the identified coloring material outputs from the ultrasonic element 73, based on the branch flow path 71, that is, the acoustic radiation force to be realized.

As a result, it is possible to suppress the inconvenience that the coloring material to be ejected from the nozzle 111 of the ejection head 10 moves to the branch flow path 71.

In the present embodiment, the ultrasonic element 73 includes the vibrator 732A having the liquid contact surface that contacts the liquid flowing through the liquid supply flow path 40, and the piezoelectric element 733 for causing flexural vibration of the vibrator 732A in the Z direction.

As a result, the ultrasonic waves can be propagated directly from the vibrator 732A to the liquid, and the ultrasonic waves having a large acoustic radiation force can be transmitted to the liquid using a low voltage.

In the present embodiment, the branch flow path 71 is provided at a position where energy becomes a minimum value in a combined field of the drag field, which is based on the force of the flow of the liquid flowing through the liquid supply flow path 40, and the acoustic radiation field, which is based on the acoustic radiation force of the ultrasonic waves transmitted from the ultrasonic generator 72.

As a result, the foreign matter to be moved to the branch flow path 71 can be captured at the connection position between the liquid supply flow path 40 and the branch flow path 71, and can be moved from the liquid supply flow path 40 to the branch flow path 71 by the gradient of the acoustic radiation force.

In the present embodiment, the liquid ejection device 1 further includes the circulation flow path 60 having one end connected to the ejection head 10 and the other end connected to the liquid supply flow path 40 via the pump 30 and the pump 30 circulates the liquid from circulation flow path 60 to liquid supply flow path 40.

As a result, the liquid can be returned from the ejection head 10 to the liquid supply flow path 40 through the circulation flow path 60 and reused. At this time, even if foreign matter is mixed in from the nozzle 111 of the ejection head 10, the foreign matter can be moved to the branch flow path 71 by the ultrasonic generator 72 provided in the liquid supply flow path 40.

In the present embodiment, the ejection head 10 includes the nozzle 111 that ejects liquid, the pressure chamber 173 that is connected to the nozzle 111 and that applies pressure to the liquid, the pressure chamber 174 that is connected to the nozzle 111 and that applies pressure to the liquid, the first common liquid chamber 171 that is connected to the pressure chamber 173 and into which liquid flows from the liquid supply flow path 40, and the second common liquid chamber 172 that is connected to the pressure chamber 174 and from which the liquid flows out to the circulation flow path 60.

As a result, the liquid sent to the ejection head 10 fills both the pressure chamber 173 and the pressure chamber 174. A part of the liquid to which pressure is applied in the pressure chamber 173 is ejected from the nozzle 111 and is sent to the pressure chamber 174. The portion of the liquid to which pressure is applied in the pressure chamber 174 flows back toward the nozzle 111 and is ejected from the nozzle 111, and the remaining liquid is sent from the circulation flow path 60 to the liquid supply flow path 40. With such a configuration, the flow velocity of the liquid flowing through the ejection head 10, the liquid supply flow path 40, and the circulation flow path 60 can be slowed, and the liquid can be circulated in a laminar flow. Therefore, the drag force due to the flow of the liquid becomes sufficiently small, making it easier to capture the foreign matter and air bubbles by the acoustic radiation force.

### Modification

The present disclosure is not limited to the above-described embodiments, and configurations obtained by modifications, improvements, appropriate combinations of the embodiments, and the like within a scope that can achieve the object of the present disclosure are included in the present disclosure.

### Modification 1

In the above embodiment, an example in which a standing wave is formed by the ultrasonic element 73 is described, but the present disclosure is not limited thereto. By forming the standing wave, the capturing force of the fine particles at the position of the node or the antinode is improved, but even if the standing wave is not formed, as described above, the energy of the acoustic radiation field becomes equal to or more than the energy of the drag field, so that the fine particles can be captured.

### Modification 2

In the above embodiment, an example was shown in which, based on the control of the control device 80, the first drive circuit 742 of the drive circuit 74 adjusts the first drive voltage to be applied to each of the ultrasonic transducers Tr in the first element region Ar1 of the ultrasonic element 73 and the second drive circuit 743 adjusts the second drive voltage to be applied to each of the ultrasonic transducers Tr in the second element region Ar2. In contrast, as a method of making the acoustic radiation force of the second region 730B larger than the acoustic radiation force of the first region 730A, the arrangement density of the ultrasonic transducers Tr in the second element region Ar2 may be made larger than the arrangement density of the ultrasonic transducers Tr in the first element region Ar1.

Alternatively, as in the above embodiment, a configuration may be adopted in which the ultrasonic elements 73 are disposed from the liquid supply flow path 40 to a portion of the branch flow path 71, and the second ultrasonic elements are disposed on the +Z side surface of the branch flow path 71 corresponding to the second region 730B of the branch flow path 71. That is, the ultrasonic waves are transmitted from the first element region Ar1 to the first region 730A, and the ultrasonic waves are transmitted from the second element region Ar2 and the second ultrasonic element to the second region 730B. As a result, the acoustic radiation force in the second region 730B can be made higher than the acoustic radiation force in the first region 730A.

### Modification 3

In the above embodiment, an example in which the liquid sent to the ejection head is returned to the liquid supply flow path 40 via the circulation flow path 60 has been shown, but the present disclosure is not limited thereto. A configuration in which the circulation flow path 60 is not provided, or a recovery section that recovers the liquid may be provided instead of the circulation flow path 60.

### Modification 4

In the above embodiment, the configuration in which the ultrasonic element 73 has the first element region Ar1 and the second element region Ar2 and the drive voltages are different between these two regions has been exemplified, but the present disclosure is not limited thereto. The ultrasonic element 73 may have three or more element regions, and these element regions may be arranged in the Y direction. A configuration may be adopted in which the ultrasonic transducers Tr arranged in the X direction are set as one channel and each channel can be individually driven. In this case, it is also possible to change the driving voltage to each element region so that the acoustic radiation force gradually increases from the −Y side toward the +Y side.

### Summary of Present Disclosure

A liquid ejection device according to the first aspect of the present disclosure includes an ejection head that ejects a liquid, a liquid supply flow path that supplies the liquid to the ejection head; an ultrasonic generator provided with an ultrasonic element that transmits ultrasonic waves in a first direction that intersects with a flow direction of the liquid in the liquid supply flow path, and a branch flow path that branches in a second direction that intersects the flow direction and the first direction from a position of the liquid supply flow path where the ultrasonic waves are transmitted, wherein the ultrasonic generator generates the ultrasonic waves such that the acoustic radiation force increases from the liquid supply flow path toward the branch flow path.

As a result, the foreign matter in the liquid is moved from the liquid supply circuit to the branch flow path by the acoustic radiation force, and thus it is possible to easily suppress the mixing of the foreign matter in the liquid flowing in the ejection head.

The liquid ejection device of the present disclosure may be such that the ultrasonic generator generates a standing wave in the first direction.

As a result, the foreign matter and the air bubbles can be captured by the node or the antinode of the standing wave, making it possible to further suppress the inflow of foreign matter and air bubbles into the liquid supply flow path.

The liquid ejection device of the present disclosure may be such that the ultrasonic generator is provided with a radiation force adjustor that adjusts the acoustic radiation force of the ultrasonic waves along the second direction.

As a result, the foreign matter captured in the liquid supply flow path can be moved toward the branch flow path.

The liquid ejection device of the present disclosure may be such that a plurality of the ultrasonic elements are disposed along the second direction and the radiation force adjustor adjusts the acoustic radiation force by adjusting each of the voltages applied to the plurality of ultrasonic elements arranged in the second direction.

As a result, it is possible to easily form the gradient of the acoustic radiation force along the second direction by driving each of the plurality of ultrasonic elements disposed along the second direction.

The liquid ejection device of the present disclosure may be such that the ultrasonic generator transmits the ultrasonic waves from the liquid supply flow path to a part of the branch flow path.

As a result, it is possible to form the gradient of the acoustic radiation force by the ultrasonic waves over a part of the branch flow path from the liquid supply flow path, making it easier for foreign matter to move to the branch flow path.

The liquid ejection device of the present disclosure may be such that the radiation force adjustor adjusts the acoustic radiation force based on size or physical properties of fine particles flowing through the branch flow path.

As a result, it is possible to suppress a disadvantage that the fine particles which are desired to flow from the liquid supply flow path to the ejection head flow to the branch flow path.

The liquid ejection device of the present disclosure may be such that the ultrasonic element includes a vibrator having a liquid contact surface that comes into contact with the liquid flowing through the liquid supply flow path, and a piezoelectric element for causing flexural vibration of the vibrator in the normal direction of the liquid contact surface.

As a result, the ultrasonic waves can be propagated directly from the vibrator to the liquid, and the ultrasonic waves with a large acoustic radiation force can be transmitted to the liquid at a low voltage.

The liquid ejection device of the present disclosure may be such that the branch flow path is provided at a position where energy becomes a minimum value in a combined field of a drag field based on the force of the flow of the liquid flowing through the liquid supply flow path and an acoustic radiation field based on the acoustic radiation force of the ultrasonic waves transmitted from the ultrasonic generator.

As a result, the foreign matter to be moved to the branch flow path can be captured at the connection position between the liquid supply flow path and the branch flow path, and can be moved from the liquid supply flow path to the branch flow path by the gradient of the acoustic radiation force.

The liquid ejection device of the present disclosure may further include a circulation flow path having one end connected to the ejection head and an other end connected to the liquid supply flow path via a pump, wherein the pump sends the liquid from the circulation flow path to the liquid supply flow path.

As a result, it is possible to reuse the liquid by returning the liquid from the ejection head to the liquid supply flow path via the circulation flow path. At this time, even if a foreign matter is mixed in from the nozzle of the ejection head, the foreign matter can be moved to the branch flow path by the ultrasonic generator provided in the liquid supply flow path.

The liquid ejection device of the present disclosure may be such that the ejection head includes a nozzle that ejects the liquid, a first pressure chamber that is connected to the nozzle and that applies pressure to the liquid, a second pressure chamber that is connected to the nozzle and that applies pressure to the liquid, a first common liquid chamber that is connected to the first pressure chamber and into which the liquid flows from the liquid supply flow path, and a second common liquid chamber that is connected to the second pressure chamber and from which the liquid flows out to the circulation flow path.

As a result, the liquid sent to the ejection head is filled into the first pressure chamber and the second pressure chamber. A part of the liquid to which the pressure is applied in the first pressure chamber is ejected from the nozzle and is sent to the second pressure chamber. A part of the liquid to which pressure is applied in the second pressure chamber flows backward toward the nozzle and is ejected from the nozzle, and the remaining liquid is sent from the circulation flow path to the liquid supply flow path. With such a configuration, the flow velocity of the liquid flowing through the ejection head, the liquid supply flow path, and the circulation flow path can be slowed, and the liquid can be circulated in a laminar flow. Therefore, even if the acoustic radiation force of the ultrasonic waves generated by the ultrasonic generator is small, the capturing force of the foreign matter by the acoustic radiation force is larger than the drag force by the flow of the liquid, and the foreign matter can be suitably moved to the branch flow path.

What is claimed is:

1. A liquid ejection device comprising:
an ejection head that ejects a liquid;
a liquid supply flow path that supplies the liquid to the ejection head;
an ultrasonic generator provided with an ultrasonic element that transmits ultrasonic waves in a first direction that intersects with a flow direction of the liquid in the liquid supply flow path; and
a branch flow path that branches in a second direction that intersects the flow direction and the first direction from a position of the liquid supply flow path where the ultrasonic waves are transmitted, wherein
the ultrasonic generator generates the ultrasonic waves such that the acoustic radiation force increases from the liquid supply flow path toward the branch flow path.

2. The liquid ejection device according to claim 1, wherein
the ultrasonic generator generates a standing wave in the first direction.

3. The liquid ejection device according to claim 1, wherein
the ultrasonic generator is provided with a radiation force adjustor that adjusts the acoustic radiation force of the ultrasonic waves along the second direction.

4. The liquid ejection device according to claim 3, wherein
a plurality of the ultrasonic elements are disposed along the second direction and
the radiation force adjustor adjusts the acoustic radiation force by adjusting each of the voltages applied to the plurality of ultrasonic elements arranged in the second direction.

5. The liquid ejection device according to claim 3, wherein
the ultrasonic generator transmits the ultrasonic waves from the liquid supply flow path to a part of the branch flow path.

6. The liquid ejection device according to claim 3, wherein
the radiation force adjustor adjusts the acoustic radiation force based on size or physical properties of fine particles flowing through the branch flow path.

7. The liquid ejection device according to claim 1, wherein
the ultrasonic element includes a vibrator having a liquid contact surface that contacts the liquid flowing through the liquid supply flow path and a piezoelectric element for causing flexural vibration of the vibrator in the normal direction of the liquid contact surface.

8. The liquid ejection device according to claim 1, wherein
the branch flow path is provided at a position where energy becomes a minimum value in a combined field of a drag field based on the force of the flow of the liquid flowing through the liquid supply flow path and an acoustic radiation field based on the acoustic radiation force of the ultrasonic waves transmitted from the ultrasonic generator.

9. The liquid ejection device according to claim 1, further comprising:
a circulation flow path having one end connected to the ejection head and the other end connected to the liquid supply flow path via a pump, wherein
the pump sends the liquid from the circulation flow path to the liquid supply flow path.

10. The liquid ejection device according to claim 1, wherein
the ejection head includes
a nozzle that ejects the liquid;
a first pressure chamber that is connected to the nozzle and that applies pressure to the liquid;
a second pressure chamber that is connected to the nozzle and that applies pressure to the liquid;
a first common liquid chamber that is connected to the first pressure chamber and into which the liquid flows from the liquid supply flow path; and
a second common liquid chamber that is connected to the second pressure chamber and from which the liquid flows out to the circulation flow path.
